(19) United States
(12) Patent Application Publication
(10) Pub. No.: US 2007/0129923 A1
(43) Pub. Date: Jun. 7, 2007

(54) Dynamic synchronizer simulation

(75) Inventors: Mark Langer, Regensburg (DE); Nathan Sheeley, Austin, TX (US); Kay Hesse, Dresden (DE); Tracy Harton, Portland, OR (US)

Correspondence Address: MEYERTONS, HOOD, KIVLIN, KOWERT & GOETZEL (AMD), P.O. BOX 398, AUSTIN, TX, 78767-0398, US

(73) Assignee: Advanced Micro Devices, Inc.

(21) Appl. No.: 11/440,944

(22) Filed: May 25, 2006

(30) Foreign Application Priority Data
May 31, 2005 (DE) 10 2005 024 917.5

(51) Int. Cl. G06F 17/50; G06G 7/62

(52) U.S. Cl. 703/13

(57) ABSTRACT

A synchronizer module is provided that may be used to facilitate the simulation of circuitry having clock domain crossing signals. A multiple-stage synchronizer may be used where at least one of the multiple synchronizer stages is dynamically enabled and disabled. The synchronizer module may have a delay unit for selectively applying a variable delay. This may allow for better modelling the real-silicon behaviour for simulation purposes to detect signal synchronization problems earlier in the flow, for instance during RTL (Register Transfer Level) design.

### BACKGROUND OF THE INVENTION

1. Field of the Invention

The invention generally relates to synchronizer modules and methods, and particularly to synchronizers which may be simulated in an RTL (Register Transfer Level) simulation.

2. Description of the Related Art

Many integrated circuit chips exist which have clock driven digital circuits which form more than one clock domain. In such devices, a first part of the digital circuitry is driven by a first clock, while a second part is driven by a second clock. The second clock may be different from the first clock and may even come from a different source. Examples of devices having multiple clock domains are computer chipsets, USB (Universal Serial Bus) host controllers, and WLAN (Wireless Local Area Network) receiver or transceiver devices. A number of other fields where an integrated circuit chip may have more than one clock domain exist in the state of the art.

In many applications, the digital circuitry in the various clock domains are not independent from each other. For example, a circuit in one of the clock domains may receive a signal from a circuit in another clock domain for further processing. That is, such devices require digital signals to cross clock domains. These clock domain crossing signals may be single-bit signals or even multiple-bit bus signals.

Taking for example the arrangement shown in FIG. 1A, a first circuit 100 is shown to receive a first clock signal clk1 while a second digital circuit 110 receives a different clock signal clk2. Thus, the two digital circuits 100, 110 are located in different clock domains. The circuit 100 in the first clock domain receives the single-bit signal bit0, and performs some digital operations on this signal. In the example of FIG. 1A, the digital circuit 100 may be a flip-flop device. The output signal of circuit 100 is then crossing the clock domain boundary as signal bit1 which reaches the second digital circuit 110. The circuit 110 generates the single-bit signal bit2 from bit1, driven by clock signal clk2.

As shown in FIG. 1B, the circuit 100 latches the incoming signal bit0 at a positive edge, i.e., when the clock signal clk1 rises up from the low to the high level. The digital circuit 110, which may also be a flip-flop device, is driven by the clock signal clk2 which is of higher frequency in the present example. At the positive edge of the second clock cycle, the flip flop 110 in the second clock domain registers a low signal. With the positive edge of the third clock cycle, a high signal is correctly latched. However, in the time between the positive edges of the second and third clock cycles, the output signal level may be undefined. This is commonly referred to as metastable state and may be particularly the case when the positive edge of the second clk2 clock cycle happens to occur near the positive edge of the clk1 clock cycle.

FIGS. 2A and 2B show similar examples where multi-bit bus signals are crossing the clock domain. In the example depicted, the bus includes three separate bit lines. As may be seen from FIG. 2B, a similar problem as discussed above with reference to FIG. 1B may occur. RTL simulation (in contrast to timing simulation at gate level) may often fail to identify incorrect bus synchronization such as that of FIG. 2A since the RTL simulator deals with all of the bus bits in the same manner, i.e. the bits are always “in phase” This example also shows that a method according to FIG. 2A may not be suited to correctly synchronize a bus into another clock domain: As FIG. 2B shows, there may be value artefacts on bus2, since not all bits experience the same delay and hence bus2 carries a value that never occured on bus1.

To solve the clock domain crossing signal problem, some synchronization facility may be added to the circuits. For instance, an additional flip-flop device 310 may be put between both digital circuits 300, 320 but within the second clock domain. This is depicted in FIG. 3A. FIG. 3B then shows that the output signals out do no longer have undefined levels.

FIG. 4A shows an example of correct clock domain crossing bus signals. A multiplexer 410 is put between the first and second digital circuits 400, 420 to either forward the output signals of the first digital circuit 400 to the second digital circuit 420, or feedback the output signal bus2 to the input port of the second circuit 420. The multiplexer 410 is driven by a capture signal. As may be seen from FIG. 4B, the output bus signals bus2 are correctly synchronized.

Thus, while clock domain crossing signal synchronization is already possible in the prior art, there are a number of structural and functional issues that may be sources of potential errors. For instance, synchronization problems may still occur if the overall circuitry design includes errors or design flaws which are difficult to observe in advance. For instance, if a signal is taken from a specific source and is independently fed through two different paths which at the end are re-convergent, proper synchronization may depend on the delay behaviour of both paths. Another common design flaw is to use the actual correct bus synchronizer structure according to FIG. 4A, but use an unsychronized signal for capture2.

As digital circuitry usually becomes quite complex, it is often not possible to detect such design errors in advance. This may then lead to functional errors which are only detected late in the design cycle, or even worse, during post-silicon verification. Due to the generally unreliable nature of such error,it is then even more difficult to find the source of the error, thus leading to increased circuit development costs.

### SUMMARY OF THE INVENTION

An improved synchronization technique is provided that may allow for better modelling real-silicon behaviour for simulation to detect signal synchronization problems earlier in the flow.

In one embodiment, an RTL simulation apparatus is provided which is adapted to simulate bus synchronization across a clock domain boundary. The apparatus comprises a first RTL design element configured to simulate circuitry in a first clock domain, and a second RTL design element configured to simulate circuitry in a second clock domain. The apparatus further comprises a third RTL design element which is configured to simulate functionality of a multiple-stage synchronizer having multiple synchronizer stages, which are each capable of generating a synchronizer signal which is different from the synchronizer signals generated by other synchronizer stages of the multiple-stage synchronizer. The third RTL design element is coupled to the second RTL design elements. The RTL simulation apparatus is adapted to dynamically enable and disable at least one of the multiple synchronizer stages.

In another embodiment, a synchronizer module is provided which is arranged to be connected to a first latching register driven by first clock, and a second latching register driven by a second clock. The first latching register outputs a first digital signal while the second latching register receives a second digital signal. The synchronizer module comprises a delay unit which is adapted to selectively delay the first digital signal by a variable delay to provide the second digital signal.

In another embodiment, there may be provided an HDL (Hardware Description Language) library comprising at least one synchronizer module as specified above.

Still a further embodiment relates to a computer readable storage medium which stores computer readable instructions that when executed by a processor, cause the processor to perform RTL simulation to simulate bus synchronization across a clock domain boundary. The computer readable storage medium comprises a first RTL design element which is configured to simulate circuitry in a first clock domain, and a second RTL design element which is configured to simulate circuitry in a second clock domain. The computer readable storage medium further comprises a third RTL design element which is configured to simulate functionality of a multiple-stage synchronizer having multiple synchronizer stages, which are each capable of generating a synchronizer signal different from the synchronizer signals generated by other synchronizer stages of the multiple-stage synchronizer. The third RTL design element is coupled to the first and second RTL design elements. The computer readable storage medium further comprises computer readable instructions to dynamically enable and disable at least one of the multiple synchronizer stages.

According to yet another embodiment, there is provided a synchronizer simulation method for simulating a digital electronic circuit forming a synchronizer module that can be connected to a first register driven by a first clock, and a second register driven by a second clock, wherein the first register outputs a first digital signal, and the second register receives a second digital signal. The method comprises selectively delaying the first digital signal by a variable delay, and providing the delayed signal as the second digital signal.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1A is a block diagram illustrating digital circuitry of two different clock domains having a single-bit clock domain crossing signal;

FIG. 1B is a timing chart illustrating signal levels of the circuitry shown in FIG. 1A;

FIG. 2A is a block diagram illustrating digital circuitry of two different clock domains with multiple-bit clock domain crossing bus signals;

FIG. 2B is a timing chart corresponding to the circuitry of FIG. 2A;

FIG. 3A is a block diagram illustrating single-bit cross domain clock signal synchronization;

FIG. 3B is a timing chart illustrating operation of the circuitry of FIG. 3A;

FIG. 4A illustrates clock domain crossing synchronization for multiple-bit bus signals;

FIG. 4B is a timing chart relating to the arrangement of FIG. 4A;

FIG. 5 is a graph illustrating a technique for static verification of bus synchronization;

FIGS. 6A to 6C illustrate embodiments of multiple-stage synchronizers that may be used for dynamic verification of single-bit or bus synchronization;

FIG. 7 illustrates another embodiment of a multiple-stage synchronizer having. two multiplexers;

FIG. 8 illustrates a multiple-stage synchronizer according to a further embodiment having a reduced number of elements;

FIG. 9A is a block diagram used to illustrate the real-time requirements of single-bit synchronization using a two-stage synchronizer;

FIG. 9B is a timing chart illustrating the operation of the arrangement shown in FIG. 9A;

FIG. 10A is a block diagram used to illustrate the real-time requirements of single-bit synchronization using a three-stage synchronizer;

FIG. 10B is a timing chart illustrating the operation of the arrangement shown in FIG. 1A;

FIG. 11A is a block diagram used to illustrate the real-time requirements of bus signal synchronization using two-stage synchronizers;

FIG. 11 B is a timing chart illustrating the operation of the arrangement shown in FIG. 11A; FIG. 12A is a block diagram used to illustrate the real-time requirements of bus signal synchronization using two-stage and three-stage synchronizers;

FIG. 12B is a timing chart illustrating the operation of the arrangement shown in FIG. 12A;

FIG.13A illustrates an embodiment of a five-stage synchronizer;

FIG. 13B is a timing chart illustrating the switching of the synchronization signal from a lower to a higher rank;

FIG. 13C is a timing chart illustrating the switching of the synchronization signal from a higher to a lower rank;

FIG. 14 is a block diagram illustrating an implementation example of a multiple-stage synchronizer according to an embodiment;

FIG. 15 is a state diagram illustrating the states which the arrangement of FIG. 14 can have; and

FIG. 16 is a block diagram illustrating an interrupt generator as another implementation example.

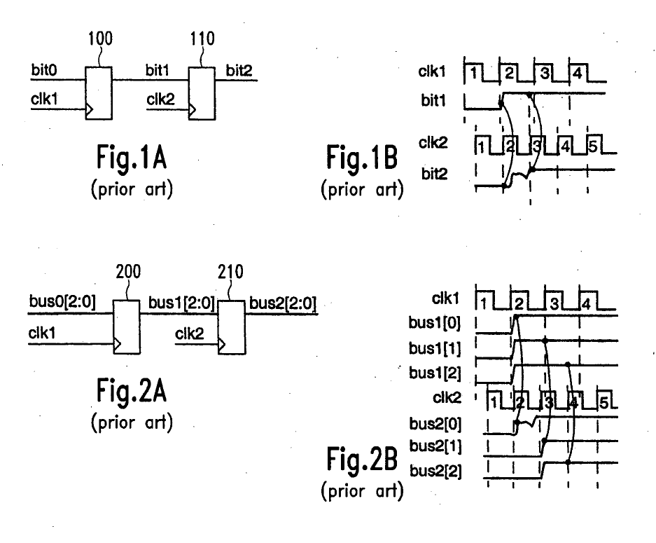

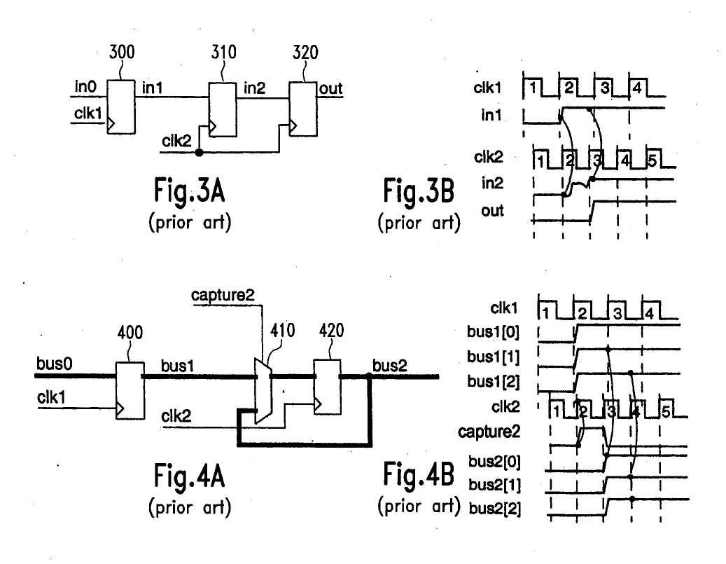

### DETAILED DESCRIPTION OF THE INVENTION

The illustrative embodiments of the present invention will be described with reference to the figure drawings wherein like elements and structures are indicated by like reference numbers.

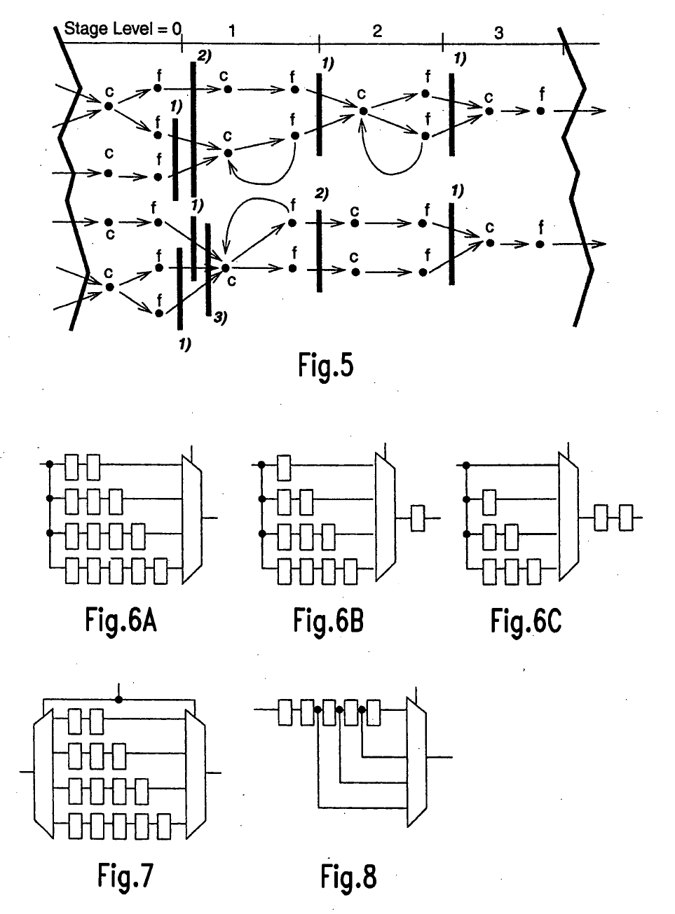

Before discussing in more detail the synchronization modules of the embodiments which provide a dynamic verification of single-bit and bus synchronization, it is referred to FIG. 5, which illustrates a static verification technique that may be used in connection with the embodiments. In this approach, the whole design structure is mapped onto a graph model which is built from vertex and edge elements. Vertices may be flops (denoted as “f” in FIG. 5) and combinational elements (denoted as “c”). Edges are depicted as wires in the graph model.

In the static verification approach, the model is partitioned into clock domains and stage levels. As may be seen from FIG. 5, the present example illustrates four different levels. Taking the example of bus synchronization, buses may be identified based on the finding that combinational logic inputs have bus requirements. In the graph of FIG. 5, different bus requirements are illustrated by means of bold vertical lines having numbers 1), 2) or 3) accompanied. It is noted that this verification approach allows for detecting the number of buses needed to achieve proper bus synchronization.

As will be described in more detail below, the embodiments may make use of multiple-stage synchronizers in a manner that allows for dynamic verification of single-bit or bus synchronization. Examples of multiple-stage synchronizers that may be used in the embodiments are shown in FIGS. 6A to 6C. In FIG. 6A, four parallely arranged register sequences are provided which all receive the same input signal. The register sequences used in FIG. 6A have two to five register elements which may be latches, flip-flop devices or other two-state systems capable of performing storage operations on clock edges. As may be seen from FIG. 6A, the output ports of each of the sequences are provided to a multiplexer which may be any selection element for selecting and outputting one of the signals.

The multiple-stage synchronizer shown in FIG. 6B differs from the one shown in FIG. 6A in that each of the register sequences is reduced in length by one element, and a single register element is added to the end of the synchronizer. It is noted that the mentioned single register element may likewise be added to the left side of the multi-stage synchronizer. The synchronizer of the embodiment of FIG. 6B may achieve the same functionality as that of FIG. 6A but has the total number of register elements reduced by three.

Referring to FIG. 6C, this concept is again applied by removing an additional one of the register elements in each of the sequences and adding a second register element at the end. Again, one or two of the extra register elements shown to be connected to the output port of the multiplexer of FIG. 6C could also be provided before the register sequences are branched out.

FIG. 7 illustrates a further embodiment that somehow resembles the synchronizer of FIG. 6A but which differs in that there is provided a second multiplexer. That is, while the register sequences in FIG. 6A each receive the same input signal, the arrangement of FIG. 7 provides an extra multiplexer. This allows for better decoupling the register sequences to increase reliability and may be particularly useful for bus synchronization.

While not shown in FIG. 7, it is noted that embodiments similar to those of FIGS. 6B and 6C would also be possible as modifications from the arrangement of FIG. 7.

Turning now to FIG. 8, a multi-stage synchronizer according to an embodiment is depicted where the number of register elements is reduced as much as possible. In the embodiment of FIG. 8, only one physical register sequence remains. To achieve multiple logical register sequences of different lengths, signals are branched off and are separately provided to the multiplexer. That is, the upper most signal provided to the multiplexer is the output signal of the entire register sequence. The second signal provided to the multiplexer is taken from the output port of the fourth register element so that it corresponds to the output signal of a register sequence having four elements. Similarly, the third and fourth signals provided to the multiplexer correspond to sequences of three and two register elements, respectively.

It is noted that in a single-bit synchronization embodiment, each of the individual register elements shown in FIGS. 6A to 6C, 7 and 8 may be single-bit registers such as flip flops. In bus synchronization embodiments, each of the register elements may be configured to temporarily store multiple bits at a time, one for each line in the bus.

In an embodiment, the selection element, such as a multiplexer, is driven in a dynamic manner to change the register sequence used. The change may be done regularly or irregularly, in a reproducible manner or not. In an embodiment, the selection device may be driven by a random or pseudo-random control signal. Using a reproducible signal such as a pseudo-random control signal may allow learning from correcting design errors by comparing the simulation results before and after the correction.

Before discussing this in more detail, the real-time requirements for single-bit signals and bus signals are discussed first.

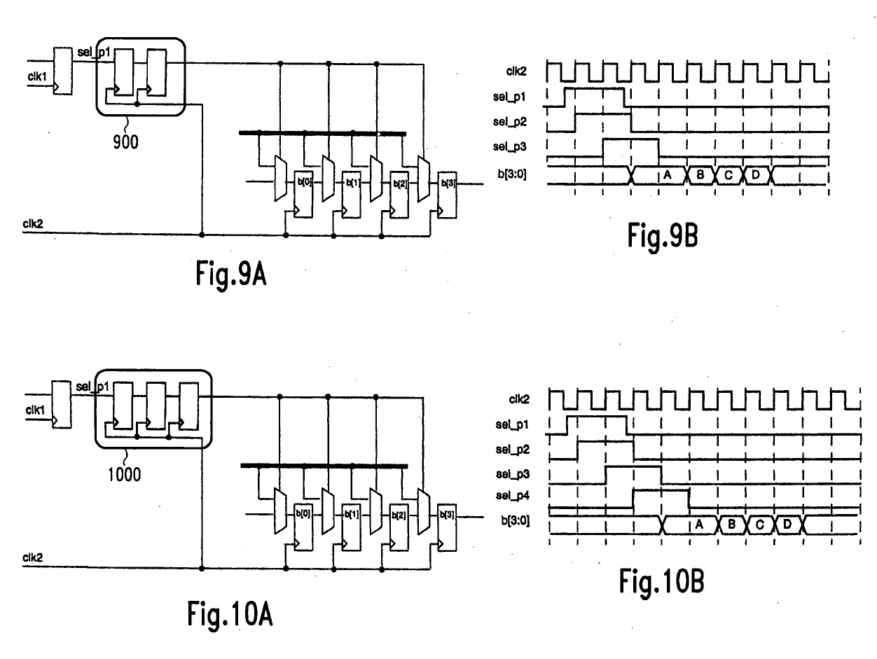

FIGS. 9A and 10A show examples using two-stage and three-stage synchronizers for single-bit synchronization. As may be seen from FIGS. 9B and 10B, the synchronization is carried out properly so that it may be concluded that single-bit signals are usually not fully real-time required.

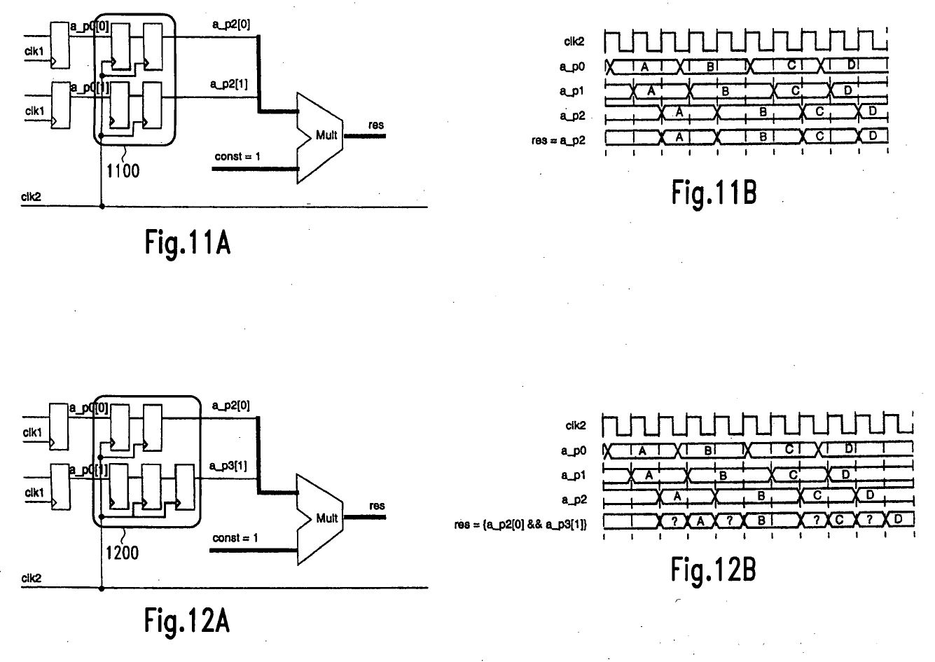

FIGS. 11A and 12A show similar arrangements for bus synchronization. The stage module 1100 of FIG. 11A applies two stages to each bit, leading to the timing chart of FIG. 11B. FIG. 12A shows an arrangement where one bit is processed by a two-stage synchronizer element while three stages are used for the second bit. It can be seen from FIG. 12B that the output signal may have undefined values leading to potential functional errors. From this it may be concluded that bus synchronization has increased real-time requirements compared with single-bit synchronization.

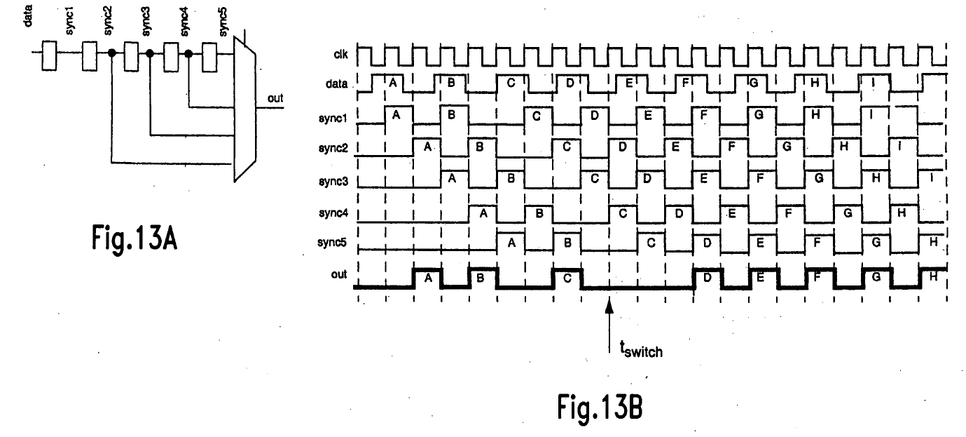

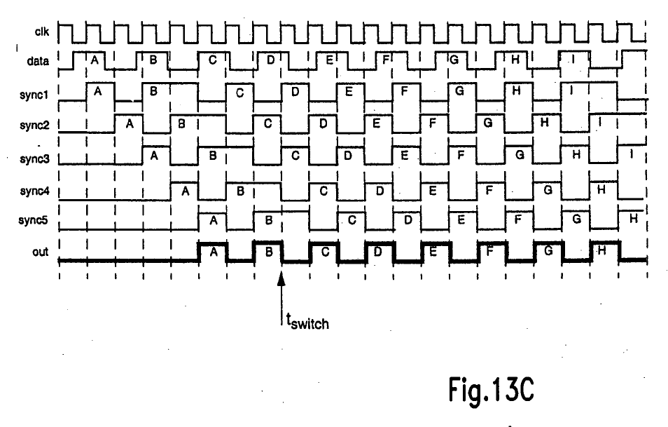

Turning to FIG. 13A, a multi-stage synchronizer is shown like that of FIG. 8. This synchronizer is now used to discuss the switching from a lower to a higher rank and vice versa, assuming that switching is possible at each positive edge clock event.

FIG. 13B shows an example where synchronization is switched from sync2 to sync5. It may be seen that the output signal properly reflects all of the incoming data although the data was crossing a clock domain.

The following is a brief summary of the timing model for switching from a lower to a higher rank, assuming that t_{switch} occurs at a positive edge of the clk signal, and T_{clk}=1/f_{clk}.

| | | | | |
|---|---|---|---|---|
| out: sync2 → sync3 | | | sync2(t); | t = (−∝, t_{switch}] |
| hold sync2(t_{switch}) for | out = | {open oversize brace} | sync2(t_{switch}); | t = t_{switch}, t_{switch} + T_{clk}] |
| 1 clk cycle before switching | | | sync3(t); | t = (t_{switch} + T_{clk}, +∝) |
| out: sync2 → sync4 | | | sync2(t); | t = (−∝, t_{switch}] |
| hold sync2(t_{switch}) for | out = | {open oversize brace} | sync2(t_{switch}); | t = (t_{switch}, t_{switch} + 2T_{clk}) |
| 2 clk cycles before switching | | | sync4(t); | t = (t_{switch} + 2T_{clk}, +∝) |
| out: sync2 → sync5 | | | sync2(t); | t = (−∝, t_{switch}] |
| hold sync2(t_{switch}) for | out = | {open oversize brace} | sync2(t_{switch}); | t = (t_{switch}, t_{switch} + 3T_{clk}] |
| 3 clk cycles before switching | | | sync5(t); | t = (t_{switch} + 3T_{clk}, +∝) |
| out: sync3 → sync4 | | | sync3(t); | t = (−∝, t_{switch}] |
| hold sync2(t_{switch}) for | out = | {open oversize brace} | sync3(t_{switch}); | t = (t_{switch}, t_{switch} + T_{clk}] |
| 1 clk cycle before switching | | | sync4(t); | t = (t_{switch} + T_{clk}, +∝) |
| out: sync3 → sync5 | | | sync3(t); | t = (−∝, t_{switch}] |
| hold sync2(t_{switch}) for | out = | {open oversize brace} | sync3(t_{switch}); | t = (t_{switch}, t_{switch} + 2T_{clk}] |
| 2 clk cycles before switching | | | sync5(t); | t = (t_{switch} + 2T_{clk}, +∝) |
| out: sync4 → sync5 | | | sync4(t); | t = (−∝, t_{switch}] |
| hold sync2(t_{switch}) for | out= | {open oversize brace} | sync4(t_{switch}); | t = (t_{switch}, t_{switch} + T_{clk}] |
| 1 clk cycle before switching | | | sync5(t); | t = (t_{switch} + T_{clk}, +∝) |

Turning now to FIG. 13C, an example is shown for switching the synchronizer from a higher to a lower rank. In the example shown in FIG. 13C, sync5 is switched to sync4. In this and other embodiments, switching may be possible at positive clock edges only, and when no data will be lost. The condition to switch one ranking level to the next lower one may be that both ranking levels must have the same value.

In the following, the timing model for down-switching the register sequences is briefly summarized, assuming t_{switch} to occur at positive clock edges.

| | | | | |
|---|---|---|---|---|
| out: sync3 → sync2 | | | sync3(t); | t = (−∝, t_{switch}] |
| switch @(posedge clk) and | out = | {open oversize brace} | | |
| (sync3 == sync2) | | | sync2(t); | t = (t_{switch}, +∝) |
| out: sync4 → sync3 | | | sync4(t); | t = (−∝, t_{switch}] |
| switch @(posedge clk) and | out = | {open oversize brace} | | |
| (sync4 == sync3) | | | sync3(t_{switch}); | t = (t_{switch}, +oc) |
| out: sync5 → sync4 | | | sync5(t); | t = (−∝, t_{switch}] |
| switch @(posedge clk) and | out = | {open oversize brace} | | |
| (sync5 == sync4) | | | sync4(t); | t = (t_{switch}, +∝) |

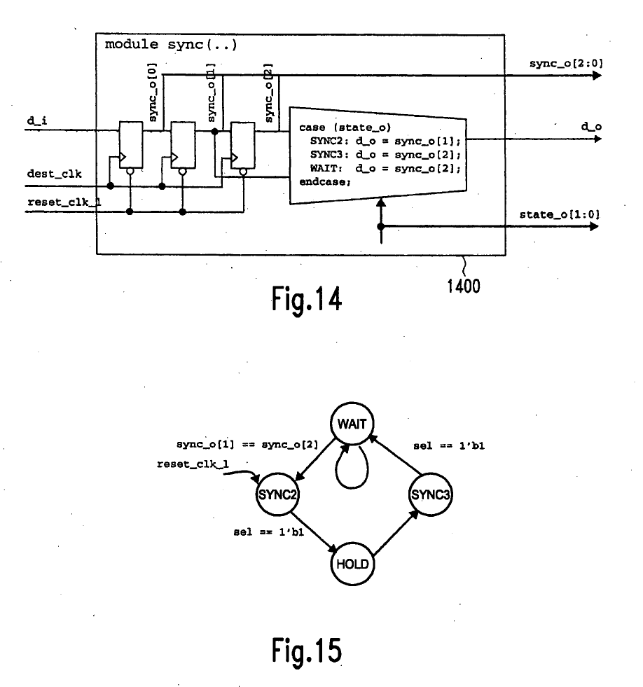

Turning now to FIG. 14, a multiple-stage synchronizer is shown as an implementation example according to an embodiment. This example switches between ranks two and three at a switching rate which may be varied by extending the bit width of the random variable sel.

FIG. 15 illustrates a state diagram that may be used with the embodiment of FIG. 14. As can be seen the synchronizer cycles through two different synchronization stages in a manner driven by the random value sel. A CRC (Cyclic Redundancy Check) generator may be used to produce reproducible pseudo-random delays of two or three clock cycles for this purpose. In another exemplary embodiment, a linear feedback shift register may be used with the polynomial 1+x³+x¹⁰. In yet another embodiment, the CRC generator may use a linear feedback shift register.

Referring back to FIG. 14, the following is exemplary Verilog code that may used in an embodiment during RTL design:

module generic_sync (

| | |
|---|---|
| dest_clk, | // destination clock |
| reset, | // async reset |
| d_i, | // asynchronous data input |
| d_o | // synchronous data output |

);

| // synopsys template | | |
|---|---|---|
| parameter CLKPOL = 1′b1; | | // clock polarity: 1: posedge, |
| | | 0: negedge |
| parameter RSTPOL = 1′b1; | | // reset polarity, 0: low active, |
| | | 1: high active |
| parameter RSTVAL = 1′b0; | | // reset value |
| parameter HASRST = 1′b1; | | // has reset |
| input | dest_clk; | // destination clock |
| input | reset; | // async reset |
| input | d_i; | // asynchronous data input |

| | | |
|---|---|---|
| output | d_o; | // synchronous data output |

| reg [1:0] sync_1; | |
|---|---|
| reg [1:0] sync_2; | // the actual flops |

| wire | int_clk = dest_clk \hat{ }˜CLKPOL;// internal clock, |
|---|---|
| | according to requeste |
| wire | int_reset = reset \hat{ }˜RSTPOL; // internal reset, according |

to requeste

always @ (posedge int_clk or posedge int_reset)

if (int_reset)

begin

sync_1[0] <= RSTVAL;
sync_1[1] <= RSTVAL;

end

else

begin

sync_1[0] <= d_i;
sync_1[1] <= sync_1[0];

end

always @ (posedge int_clk)

begin

sync_2[0] <= d_i;
sync_2[1] <= sync_2[0];

end

assign d_o = HASRST ? sync_1[1] : sync_2[1];

endmodule // generic_sync

By applying variable delays in the manner described above, the embodiments allow for modelling real-silicon behaviour for simulation purposes to detect signal synchronization problems very early in the design flow, for instance during RTL design. Generally, the embodiments may make use of synchronizer modules defined using any HDL (Hardware Description Language) syntax and semantics. The synchronizer modules may be separately defined, or provided as part of a library.

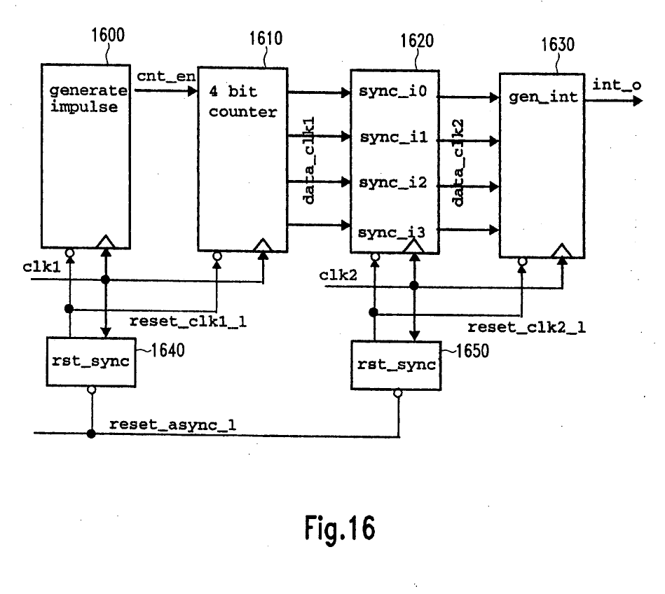

A simulation example of an interrupt generator is shown in FIG. 16. This circuitry may exhibit an incorrect bus synchronization which the technique of the embodiments can reveal already in the RTL design phase. In FIG. 16, the synchronizer module is provided as block 1620. An impulse generator 1600 provides a signal to a 4-bit counter 1610 to enable the counter to count upwards. Further, an input generation unit gen_int 1630 receives the output of the synchronizer 1620 to generate and output an interrupt. The impulse generator 1600 together with the 4-bit counter 1610 on the one side, and the synchronizer 1620 and the input generator 1630 on the other side, form different clock domains. It is noted that separate reset synchronizers 1640 and 1650 may be provided for the clock domains.

As described above, a simulation technique is provided to simulate a, e.g. two-stage, flip flop synchronizer. In simulation (but not later in implementation on the silicon) a switching logic switches between, e.g., two and three cycle delays. This simulates the real silicon circuit behaviour where signal delays may sometimes vary for many reasons. With respect to bus synchronization, embodiments may bring individual bus bits “out of phase” (in contrast to conventional RTL simulators which deal with all of the bus bits in the same manner) so that the designer may notice an incorrect RTL description early in the flow.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

What is claimed is:

1. An RTL (Register Transfer Level) simulation apparatus adapted to simulate bus synchronization across a clock domain boundary, comprising:
a first RTL design element configured to simulate circuitry in a first clock domain;
a second RTL design element configured to simulate circuitry in a second clock domain; and
a third RTL design element configured to simulate functionality of a multiple stage synchronizer having multiple synchronizer stages each capable of generating a synchronizer signal different from the synchronizer signals generated by other synchronizer stages of the multiple stage synchronizer, the third RTL design element being coupled to the first and second RTL design elements,
wherein the RTL simulation apparatus is adapted to dynamically enable and disable at least one of the multiple synchronizer stages.

2. The RTL simulation apparatus of claim 1, wherein said multiple synchronizer stages are configured to simulate flip flop registers.

3. The RTL simulation apparatus of claim 1, wherein said third RTL design element is configured to apply a dynamically varying time delay in a data path from said first RTL design element to said second RTL design element by dynamically enabling and disabling at least one of the multiple synchronizer stages.

4. The RTL simulation apparatus of claim 1, wherein said multiple stage synchronizer has a first and a second synchronizer stage, and said third RTL design element comprises: an RTL selection element connected to an output port of said first synchronizer stage and to an output port of said second synchronizer stage, and adapted to select either an output signal of said first synchronizer stage or an output signal of said second synchronizer stage.

5. The RTL simulation apparatus of claim 4, wherein said second synchronizer stage is connected to said first synchronizer stage to receive as input signal said output signal of said first synchronizer stage.

6. The RTL simulation apparatus of claim 5, wherein said first and second synchronizer stages are adapted to apply the same time delays to respective input signals.

7. The RTL simulation apparatus of claim 4, wherein said first and second synchronizer stage are adapted to apply different time delays to respective input signals.

8. The RTL simulation apparatus of claim 1, adapted to randomly enable and disable said at least one of the multiple synchronizer stages.

9. The RTL simulation apparatus of claim 8, further comprising a pseudo random control signal generator element adapted to control randomly enabling and disabling said at least one of the multiple synchronizer stages.

10. The RTL simulation apparatus of claim 9, wherein said pseudo random control signal generator element is configured to simulate a CRC (Cyclic Redundancy Check) generator.

11. The RTL simulation apparatus of claim 9, wherein said pseudo random control signal generator comprises a linear feedback shift register.

12. A synchronizer module arranged to be connected to a first latching register driven by a first clock, and a second latching register driven by a second clock, said first latching register outputting a first digital signal, said second latching register receiving a second digital signal, the synchronizer module comprising:
a delay unit adapted to selectively delay said first digital signal by a variable delay to provide said second digital signal.

13. The synchronizer module of claim 12, wherein said delay unit comprises:
a first delay subunit;
a second delay subunit; and
a selection unit connected to an output port of said first delay subunit and to an output port of said second delay subunit, and adapted to select as said second digital signal either an output signal of said first delay subunit or an output signal of said second delay subunit.

14. The synchronizer module of claim 13, wherein said second delay subunit is connected to said first delay subunit to receive as input signal said output signal of said first delay subunit.

15. The synchronizer module of claim 14, wherein said first and second delay subunits are adapted to apply the same delays to respective input signals.

16. The synchronizer module of claim 13, wherein said first and second delay subunits are adapted to apply different delays to respective input signals.

17. The synchronizer module of claim 12, wherein said delay unit is adapted to randomly change said variable delay.

18. The synchronizer module of claim 17, further comprising a pseudo random control signal generator adapted to control randomly changing said variable delay.

19. The synchronizer module of claim 18, wherein said pseudo random control signal generator is a CRC (Cyclic Redundancy Check) generator.

20. The synchronizer module of claim 18, wherein said pseudo random control signal generator comprises a linear feedback shift register.

21. The synchronizer module of claim 12, wherein said first and second digital signals are multiple-bit bus signals.

22. The synchronizer module of claim 12, wherein said first and second digital signals are single-bit signals.

23. The synchronizer module of claim 12, arranged to be connected to a first and second flip flop as latching registers.

24. The synchronizer module of claim 12, wherein said variable delay is a delay changing between two and three clock cycles.

25. The synchronizer module of claim 12, being an RTL (Register Transfer Level) synchronizer module.

26. An HDL (Hardware Description Language) library comprising at least one synchronizer module as claimed in claim 12.

27. A computer readable storage medium storing computer readable instructions that when executed by a processor cause the processor to perform RTL (Register Transfer Level) simulation to simulate bus synchronization across a clock domain boundary, comprising:
a first RTL design element configured to simulate circuitry in a first clock domain;
a second RTL design element configured to simulate circuitry in a second clock domain;
a third RTL design element configured to simulate functionality of a multiple stage synchronizer having multiple synchronizer stages each capable of generating a synchronizer signal different from the synchronizer signals generated by other synchronizer stages of the multiple stage synchronizer, the third RTL design element being coupled to the first and second RTL design elements; and
computer readable instructions to dynamically enable and disable at least one of the multiple synchronizer stages.

28. The computer readable storage medium of claim 27, wherein said multiple synchronizer stages are configured to simulate flip flop registers.

29. The computer readable storage medium of claim 27, wherein said third RTL design element is configured to apply a dynamically varying time delay in a data path from said first RTL design element to said second RTL design element by dynamically enabling and disabling at least one of the multiple synchronizer stages.

30. The computer readable storage medium of claim 27, wherein said multiple stage synchronizer has a first and a second synchronizer stage, and said third RTL design element comprises:
an RTL selection element connected to an output port of said first synchronizer stage and to an output port of said second synchronizer stage, and adapted to select either an output signal of said first synchronizer stage or an output signal of said second synchronizer stage.

31. The computer readable storage medium of claim 30, wherein said second synchronizer stage is connected to said first synchronizer stage to receive as input signal said output signal of said first synchronizer stage.

32. The computer readable storage medium of claim 31, wherein said first and second synchronizer stages are adapted to apply the same time delays to respective input signals.

33. The computer readable storage medium of claim 30, wherein said first and second synchronizer stages are adapted to apply different time delays to respective input signals to perform bus synchronization simulation.

34. The computer readable storage medium of claim 27, wherein said computer readable instructions are adapted to randomly enable and disable said at least one of the multiple synchronizer stages.

35. The computer readable storage medium of claim 34, further comprising a pseudo random control signal generator element adapted to control randomly enabling and disabling said at least one of the multiple synchronizer stages.

36. The computer readable storage medium of claim 35, wherein said pseudo random control signal generator element is configured to simulate a CRC (Cyclic Redundancy Check) generator.

37. The computer readable storage medium of claim 35, wherein said pseudo random control signal generator comprises a linear feedback shift register.

38. A synchronizer simulation method for simulating a digital electronic circuit forming a synchronizer module connectable to a first register driven by a first clock and a second register driven by a second clock, the first register outputting a first digital signal, the second register receiving a second digital signal, the method comprising:
selectively delaying said first digital signal by a variable delay; and
providing the delayed signal as said second digital signal.

39. The synchronizer simulation method of claim 38, wherein selectively delaying comprises:
applying a first delay;
applying a second delay; and
selecting as said second digital signal either a signal delayed by applying said first delay or a signal delayed by applying said second delay.

40. The synchronizer simulation method of claim 39, wherein said second delay is applied to said signal delayed by applying said first delay, to generate said signal delayed by applying said second delay.

41. The synchronizer simulation method of claim 40, wherein said first delay is equal to said second delay.

42. The synchronizer simulation method of claim 39, wherein said first delay is different from said second delay.

43. The synchronizer simulation method of claim 38, wherein selectively delaying said first digital signal comprises:
randomly changing said variable delay.

44. The synchronizer simulation method of claim 43, further randomly changing said variable delay comprises:
operating a pseudo random signal generator to control randomly changing said variable delay.

45. The synchronizer simulation method of claim 44, wherein said pseudo random signal generator is a CRC (Cyclic Redundancy Check) generator.

46. The synchronizer simulation method of claim 44, wherein said pseudo random signal generator comprises a linear feedback shift register.

47. The synchronizer simulation method of claim 38, wherein said first and second digital signals are multiple-bit bus signals.

48. The synchronizer simulation method of claim 38, wherein said first and second digital signals are single-bit signals.

49. The synchronizer simulation method of claim 38, wherein said variable delay is a delay changing between two and three clock cycles.

50. The synchronizer simulation method of claim 38, adapted to be performed at RTL (Register Transfer Level) design level.
